(19) United States
(12) Patent Application Publication
(10) Pub. No.: US 2023/0370494 A1
(43) Pub. Date: Nov. 16, 2023

(54) QUANTUM SECURE DIRECT COMMUNICATION WITH MUTUAL AUTHENTICATION VIA ROTATION OF AN ARBITRARY BASIS

(71) Applicant: QULABZ INC., Kendal Park, NJ (US)

(72) Inventors: Nayana DAS, West Bengal (IN); Goutam Kumar PAUL, Kolkata (IN)

(21) Appl. No.: 17/894,801

(22) Filed: Aug. 24, 2022

(30) Foreign Application Priority Data
Aug. 25, 2021 (IN) 202131038586

(51) Int. Cl. H04L 9/40; H04L 9/08

(52) U.S. Cl. CPC H04L 63/1483; H04L 9/0852; H04L 9/0869; H04L 63/0869; H04L 63/1416; H04L 63/1491; H04L 2463/041

(57) ABSTRACT

Approaches for implementing quantum secure direct communication (QSDC) with mutual authentication are described. In an example, an encoded sequence of single-qubit states corresponding to bits within a bit string message may be prepared. The sequence of the single-qubit states in turn are prepared based on a randomly selected arbitrary basis. The encoded sequence once prepared may be transmitted to a receiving system over a quantum communication channel.

### BACKGROUND

### Technical Field

This disclosure is in the field of quantum computing and more particularly in the field of ensuring secure communication in quantum computing systems.

### Description of the Related Art

Security of communication between two or multiple parties is a fundamental criterion for evaluating performance of any communication network. Traditional communication schemes are secured through encryption techniques, relying on pre-shared key and cryptographic protocols built on the computational difficulty of certain mathematical problems, for example, the RSA public key scheme. For example, classical cryptography may involve symmetric or private key cryptography and asymmetric or public key cryptography. Such schemes have their own set of advantages as well as technical challenges. With the advent of quantum computing, the security of such traditional cryptographic communication has become a concern.

Quantum communication, in principle, provides unconditional security for exchanging information over public channels, since its security is based on the distinct characters based on quantum mechanics, such as quantum entanglement. In such implementations, ‘eavesdroppers’ may not gleam any useful information during a quantum communication process without introducing perturbations that inevitably reveal their interception, and also impact the integrity of the message itself.

Certain approaches, such as Quantum Key Distribution addresses certain issues pertaining traditional modes of secure communication. Another protocol, referred to as Quantum Secure Direct Communication (QSDC) has been developed which involves communication of information directly without key distribution. This in turn reduces security loopholes associated with key storage and cipher text attacks, offering a different mechanism for secure communication protocols.

### BRIEF SUMMARY

This disclosure describes a system and method to achieve increased security for communication in a quantum computing system.

According to one embodiment, a quantum communication system includes a quantum processing unit. A quantum processing unit includes electronic circuits, such as computer chips and other components. It could therefore be called a quantum processor or quantum processor circuit or a quantum controller. There is an encoding engine coupled to the quantum processing unit that is able to prepare an encoded sequence of single-qubit states corresponding to bits within a bit string message, wherein the sequence of the single-qubit states is prepared based on a randomly selected arbitrary basis and wherein the bit string message is based on an n-bit message to be transmitted to the receiving system and transmit the encoded sequence to a receiving system over a quantum communication channel and further transmit, to the receiving system, positions of qubits of a sequence of single qubits for decoding the encoded sequence by the receiving system.

According to one embodiment, the positions of qubits of the sequence of single qubits are shared over a classical communication channel. Further, the encoding engine to prepare the encoded sequence performs the following: introduce a plurality of random check bits at random locations within the n-bit message to obtain the bit string message; and generates a message sequence comprising a number of single qubits in a selected basis corresponding to each bit of the bit string message.

### BRIEF DESCRIPTION OF THE SEVERAL VIEWS OF THE DRAWINGS

Systems and/or methods, in accordance with examples of the present subject matter are now described and with reference to the accompanying figures, in which:

FIG. 1 illustrates a communication environment for quantum secure direct communication based on a single orthogonal basis, as per an example;

FIG. 2 illustrates a quantum computing system for quantum secure direct communication based on a single orthogonal basis, as per an example;

FIG. 3 illustrates method steps in a functional sequential flow for quantum secure direct communication based on a single orthogonal basis, as per one example; and

FIGS. 4-7 illustrates various example methods for performing security, authentication, and decoding while quantum secure direct communication based on a single orthogonal basis.

### DETAILED DESCRIPTION

Security is a crucial criterion for evaluating performance of any communication network. Traditional communication schemes are secured through encryption techniques, relying on pre-shared key and cryptographic protocols built on the computational difficulty of certain mathematical problems, for example, the RSA public key scheme. For example, classical cryptography may involve symmetric or private key cryptography and asymmetric or public key cryptography.

As mentioned above, a variety of quantum communication protocols are being developed. For example, quantum cryptography provides unconditional security based on the fundamental principles of quantum mechanics. One of such approaches, is quantum key distribution (QKD). Such techniques use various quantum mechanical principles, such as quantum superpositions or quantum entanglement. Systems implementing such approaches may transmit information in quantum states.

Quantum secure direct communication (QSDC) is also emerging as an important branch of quantum communication, based on the principles of quantum mechanics for the direct transmission of information. QSDC enables transmission of messages directly without establishing some prior key for encryption and decryption. QSDC may be used to transmit the message deterministically through a quantum channel. Since QSDC protocols involve direct transmission of messages through the quantum channel, they typically may require higher security than QKD protocols. Such approaches may be prone to various issues, such information leakage problem, should messages be transmitted using QSDC based protocols. In addition, some implementations of such approaches have been found to be not secure against ‘intercept-and-resend’ attacks.

One of the aspects that will further security in a communication is identity authentication. Identity authentication is critical as it prevents an eavesdropper to impersonate a legitimate party or parties within a communication session. Quantum cryptographic protocol generally utilize either entangled states or single qubit states which may be randomly prepared in a pair of orthogonal bases, to transmit information securely. Even in such cases, identity authentication is one of the important communication parameters that are to be upheld.

Approaches for implementing quantum secure direct communication (QSDC) with mutual authentication are described. In the proposed invention, the QSDC based communication utilizes a single orthogonal basis for implementing such mutual authentication. The single orthogonal basis may be chosen randomly from a predefined finite set of bases comprising a plurality of single qubit states for encoding a message that is to be transmitted.

To this end, the QSDC communication involves a sender preparing a sequence of single-qubit states corresponding to their message in a randomly chosen arbitrary basis. The prepared sequence of the single-qubit states may then be shared by the sender with a receiver through a quantum channel. Thereafter, the sender may then publicly transmit some assessment information to ascertain the security of the channel. The assessment information may be any classical information that may be transmitted through the quantum channel. In case it is determined that an eavesdropper is present in the channel, the communication session may be terminated. On the hand, if no eavesdropper is determined to be present, subsequent steps of the communication protocol, as described further, may be implemented. Once the veracity of the quantum channel is ascertained, the intended receiver may uses the information of the sender to process the received qubits and to derive the secret message.

As mentioned previously (and is will be discussed further in the present explanation), the present communication protocol utilizes a single orthogonal basis to encode the message which is to be sent to the receiver. However, since the basis is chosen arbitrarily, detection and unauthorized retrieval of message by any eavesdropper is avoided and therefore the protocol remains secure. These approaches may be implemented in a variety of quantum hardware. In an example, the measurement may be in |0〉, |1〉 basis and thus may not require additional computational resources.

Implementation of the above approaches exhibit greater security in communication of messages and have been found to be resilient against conventional attack strategies, and efficiently prevent eavesdropper from obtaining access to the encoded messages. Furthermore, the approaches when implemented on quantum devices is also found to be less susceptible to noise in quantum devices and is robust to error. These approaches and other examples are further described in the conjunction with the accompanying figures.

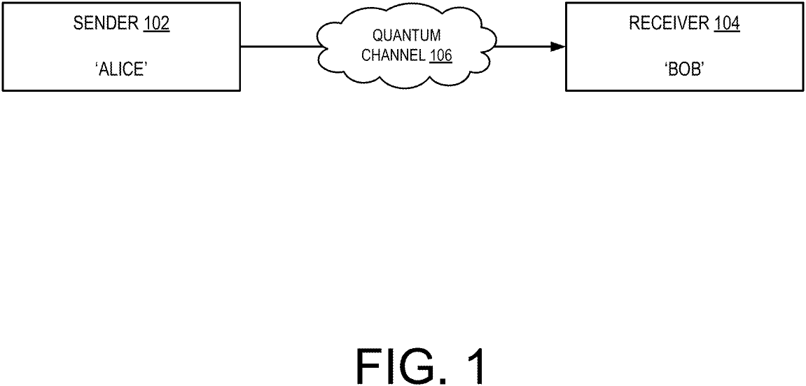

FIG. 1 is a block diagram illustrating a communication environment 100 for QSDC using single qubits, according to an example of the present subject matter. The communication environment 100 is explained in the context of a sender 102 (denoted with the archetype ‘Alice’) and a receiver 104 (denoted with the archetype Bob). Both Alice and Bob in turn may be communicating over a quantum communication channel 106. It may be noted that the reference to Alice and Bob indicate references to systems which may be in the process of sending or transmitting and receiving messages, respectively, or otherwise engaging in quantum direct secure communication using single qubits. The same are used for ease of reference and explanation and should not be used as limiting the scope of the claimed subject matter in any way.

In the context of the present process, Alice and Bob may maintain their previously shared k-bit authentication identities. In an example, the number k may be even. The respective identities may in turn be denoted by Id_{A} and Id_{B} respectively. The identities may be based on a quantum key distribution (QKD) established earlier. For the purposes of explanation, we will denote that the message which Alice wishes to securely communicate to Bob, as M. The message M in turn may include sub-messages M = M₁M₂....Mₙ. Let Θ be a predefined ordered set of angles with finite cardinality N. For each θ ∈ Θ, a unitary matrix U_{θ} is defined as:

$${U}_{θ} = \left(\begin{matrix}cos θ & - sin θ \\ sin θ & cos θ\end{matrix}\right)$$

For the above, U_{θ}|0〉 = Cos θ |0〉 + Sin θ|1〉 = |x〉 and U_{θ}|1〉 = Cos θ|1〉 - Sin θ |0〉 = |y〉. It may be noted that the above is one of the many other ways a state may be represented. Such other examples would also be within the scope of the present subject matter without any limitations. Continuing with the communication between Alice and Bob, in an example, take Θ = {x° : x is an integer and 1 ≤ x ≤ 360}. Thus here, N = 360. Note that, one can use an ordered set of real angles instead of integer angles, i.e., Θ = {x°₁, x°₂, ..., x°_{N}}, where each xᵢ ∈ R for 1 ≤ i ≤ N. In either case, to encode θ = x°ᵢ, Alice just encodes the [log₂N] bit binary representation, where [log₂N] denotes the smallest integer no smaller than log₂N.

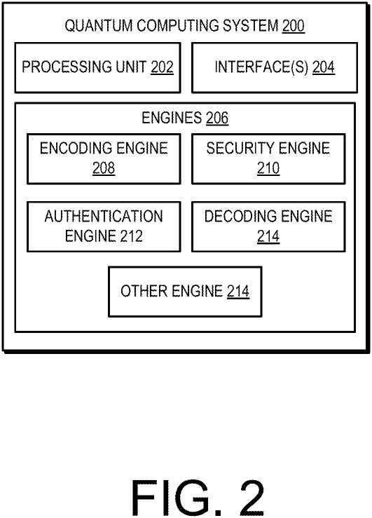

Continuing further, both the sender 102 (i.e., Alice) and the receiver 104 (i.e., Bob) may be implemented as the quantum computing system 200 as illustrated in FIG. 2. FIG. 2 depicts a quantum computing system 200 (hereinafter referred to as system 200) for implementing quantum secure direct communication using a single orthogonal basis. In an example, the system 200 may include a processing unit 202, interfaces 204 and engines 206. The processing unit 202 may include qubit processors or similar circuitry which may be implementing a quantum qubit processor. The interfaces 204 enable communication of the signals or data between different logical layers (not depicted for sake of brevity) constituting the quantum computing system 200. In an example, the interfaces 204 may enable the sender 102 (when implemented as the system 200) to communicate with the receiver 104 (also implemented as the system 200) over a quantum communication channel. It may be noted that the system 200 may include further supporting infrastructure, hardware and accompanying equipment and classical processing machines, collectively functioning for implementing the quantum computing system 200. These are also not depicted for sake of brevity and or ease in explanation.

The engines 206 may be implemented as a combination of hardware and programming, for example, programmable instructions to implement a variety of functionalities. In examples described herein, such combinations of hardware and programming may be implemented in several different ways. For example, the programming for the engines 206 may be executable instructions. In an example, the engines 206 may include a processing resource, for example, either a single processor or a combination of multiple processors, to execute one or more instructions. In the present examples, the non-transitory machine-readable storage medium may store instructions, that when executed by the processing resource, implement engines 206. In other examples, the engines 206 may be implemented as electronic circuitry.

The engines 206 may further include an encoding engine 208, a security engine 210, an authentication engine 212, a decoding engine 214 and other engines 216. The encoding engine 208 and the decoding engine 214 are enable the system 200 to receive as well as transmit messages. It may be noted that the decoding engine 214 would be functional if the system 200 were to be receiving encoded messages from a sender. On the other hand, the encoding engine 208 would be operative For example, the decoding engine 214 may be implemented within the sender 102 (i.e., Alice) for decoding encoded messages received from the receiver 104 (i.e., Bob), and vice versa.

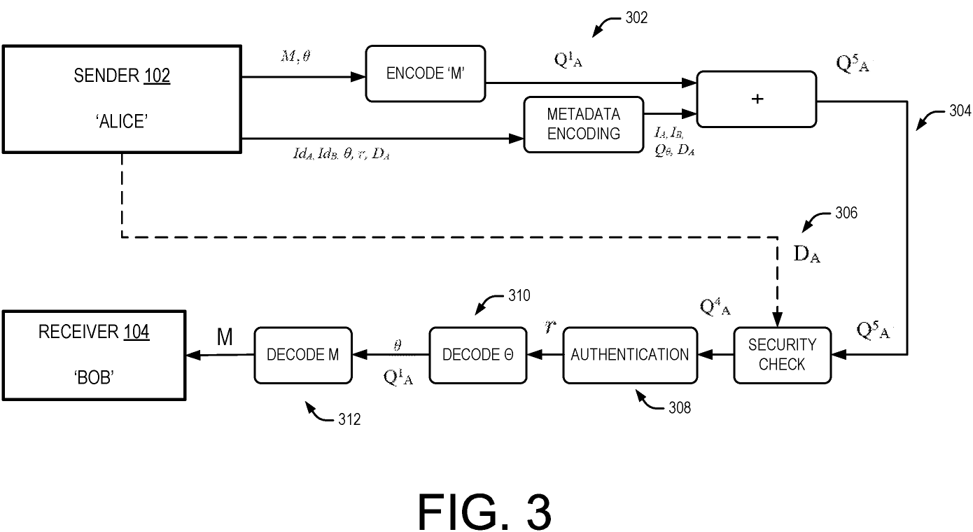

The functioning of the system 200 is now described with respect to different processes undertaken by any one or more of the engines 206 and in conjunction with FIG. 3. FIG. 3 depicts a flow diagram illustrating a functional and sequential flow of various steps 300 for implementing quantum secure direct communication based on a single orthogonal basis. Each of the different steps are thereafter described in detail in the following description. It may be noted that the process depicted is one of the many other examples that may still fall within the scope of the claimed subject matter. The entire process is explained with respect to the components of the system 200, which may be either the sender 102 or the security engine 210.

In operation, the encoding engine 208 of the sender 102 may initially obtain a message M which is to be communicated to the receiver 104. Within the sender 102, the encoding engine 208 may encode the message M. In an example, the message M may be a n-bit message M, representable as M₁M₂M₃M₄...Mₙ. Continuing with the present example, the encoding process may begin with the encoding engine 208 introducing one or more random check bits at random positions of the n-bit message M which is to be sent to Bob, i.e., the receiver 104. With the random check bits are introduced, the resulting message (with the encoded random check bits) may be denoted as M′, which includes n′ = n + c bits, where c is the number of check bits that have been introduced by the encoding engine 208.

Once the updated message stream M′ is obtained, the encoding engine 208 may further obtain a sequence Q¹_{A} (as depicted by step 302). The sequence Q¹_{A} is such that it comprises n′ number of single qubits in {|0〉, |1〉} basis corresponding to M′. It may be noted that the |0〉, |1〉 basis correspond to message bit 0 and 1, respectively. Thereafter, the encoding engine 208 may select an angle θ, wherein θ ∈ Θ. With the angle θ thus selected, the encoding engine 208 may thereafter apply a unitary operator on all qubits of the sequence obtained in step 302. In an example, the encoding engine 208 may apply the unitary operator denoted by the operator U_{θ} on all the qubits of Q¹_{A}. This results in all the qubits of Q¹_{A} to be now in {|x〉, |y〉} basis.

In a corresponding step, the encoding engine 208 may further receive a prepared sequence of single qubits I_{A}, wherein I_{A} corresponds to the authentication identity Id_{A} of the sender 102 (i.e., Alice’s). In an example, for 1 ≤ i ≤ k/2 (with k being an even number), the encoding engine 208 may elect the i-th qubit of I_{A} as |0〉, |1〉 and

$$\begin{matrix}\left|+\right〉 = \frac{1}{\sqrt{2}} \left(\left|0\right〉 + \left|1\right〉\right) \text{and} \\ \left|-\right〉 = \frac{1}{\sqrt{2}} \left(\left|0\right〉 - \left|1\right〉\right)\end{matrix}$$

according to the values 00,01,10 and 11 of the (2i-1)-th and the 2i-th bits of Id_{A}. Thereafter, the encoding engine 208 may insert qubits of I_{A} into Q¹_{A} to provide a new sequence Q²_{A}. In an example, the Q²_{A} may include n′ + k/2 number of qubits.

It may be noted that the sender 102 (implemented as the system 200) may obtain another sequence of single qubits I_{B} may be obtained. In an example, the sequence I_{B} may be obtained by choosing a k-bit random number r, with the encoding engine 208 providing a sequence of single qubits corresponding to the bit strings Id¹_{B} and Id_{B}, wherein Id¹_{B} = Id_{B} ⊕ r. In this case, for 1 ≤ i ≤ k, the i-th bit of IdB (Id¹_{B}) may be considered as Id_{B,i} (Id¹_{B,i}), for the following conditions:
i.
$$\text{if} I {d}_{B , i}^{1} \vert = 0 \left(1\right)$$
and Id_{B,i} = 0, then the i-th qubit of I_{B} is |0〉 (|1〉),
ii.
$$\text{if} I {d}_{B , i}^{1} = 0 \left(1\right)$$
and Id_{B,i} = 1, then the i-th qubit of I_{B} is |+〉 (|-〉).

With the above in place, the encoding engine 208 may obtain a new sequence of Q³_{A} by inserting the qubits of I_{B} into Q²_{A}, which may include n′ + 3k/2 number of qubits. Thereafter, the encoding engine 208 may further encode a value of θ by preparing a sequence of single qubits Q_{θ} corresponding to the binary representation of θ = θ₁θ₂ ...θ_{k′} containing k′ bits. It may be noted that since θ is an integer, whose value lies between 0 to 360, the value of k′ may be ‘9’. For purposes of the present example, for k ≥ k′, the encoding strategy, for 1 ≤ i ≤ k′, may be represented as follows:
i. if θᵢ = 0 (1) and Id_{B,i} = 0, then prepares |0〉 (|1〉),
ii. if θᵢ = 0 (1) and Id_{B,i} = 1, then prepares |+〉 (|-〉).
It may be noted that the above-mentioned encoding strategy adopted by the encoding engine 208 is only indicative. Other encoding strategies, as the conditions require, may also be used without deviating from the scope of the present subject matter. In a similar manner, a new sequence Q⁵_{A} is generated. Thus, the aforesaid qubit stream may include l = n′+ 3k/2 + k′ +m single qubits. The sequence Q⁵_{A} may then transmitted by the encoding engine 208 through the quantum channel as depicted in step 304 (e.g., the quantum communication channel 106).

The sender 102 (i.e., Alice) may further choose a sequence of decoy photons to be inserted into random positions within a qubit stream. In an example, the security engine 210 may select a sequence D_{A} of m number of decoy photons randomly from {|0〉, |1〉, |+〉, |-〉} and inserts them in random positions of Q⁴_{A} (depicted in step 306). After the receiver 104 (i.e., Bob) receives the sequence Q⁵_{A}, the security engine 210 may further assess if any eavesdropper is or was present in the quantum communication channel 106. To this end, the security engine 210 within the sender 102 (i.e., Alice) may announce the positions and bases of the decoy photons (that were transmitted in step 304). A security engine (similar to the security engine 210) in the receiver 104 (i.e., Bob) may measure the decoy photons and accordingly communicate the results to Alice. The security engine 210 within Alice may compare the measurement results communicated by Bob and the initial states of the decoy photons, to determine presence of any error in the quantum communication channel 106. If the security engine 210 determines the estimated error to be greater than a predefined threshold value, presence of an eavesdropper may be thus ascertained. If this is so determined, the security engine 210 may terminate the session between Alice and Bob (i.e., between the sender 102 and the receiver 104) and reinitiate communication as per the steps described above. If no eavesdropper is detected, the process may further continue as further described.

Once the security of the quantum communication channel 106 is ascertained, the authentication engine 212 may further authenticate and confirm the identity of the receiver 104 (i.e., Bob), as denoted by step 308. The authentication engine 212 within Alice may communicate positions of the single qubits of I_{A}. The positions of the single qubits upon being received, may be measured by Bob (e.g., by the authentication engine 212 in the receiver 104) in proper bases corresponding to Id_{A}. In an example, the receiver 104 may choose {|0〉, |1〉} as the basis if the corresponding bits of Id_{A} are 00 or 01. In another instance, receiver 104 may elect {|+〉,|-〉} as the basis if the corresponding bits of Id_{A} are 10 or 11. Once the selection of the basis is made, Bob (i.e., the receiver 104) may the measurement results with the bits of Id_{A} to determine an error rate. A low error rate implies that there is no eavesdropper impersonating Alice, thereby authenticating the identity of the sender 102. If, however, the error rate is greater than a predefined value, the communication session between Alice and Bob may be terminated.

In a similar manner, the authenticity of the receiver 104 (i.e., Bob) may also be verified. To this end, the sender 102 may communicate positions of the single qubits of I_{B} to the receiver 104 (i.e., to Bob). The receiver 104, on receiving the qubits in the proper bases corresponding to Id_{B}. In an example, the receiver 104 (i.e., the authentication engine 212 of the security engine 210) may select {|0〉, |1〉} or {|+〉,|-〉} as the basis if the corresponding bit of Id_{B} is 0 or 1, respectively based on which the identity of sender 102 may be determined. In an example, the authentication engine 212 of the receiver 104 may determine Id¹_{B} and accordingly communicates r = Id_{B} ⊕ Id¹_{B}. The communicated value of r is processed by the authentication engine 212 of sender 102 to confirm the identity of the receiver 104 (i.e., Bob). Based on the determination, the communication session may be maintained or may be terminated.

Once the identity of the sender has been ascertained, the encoded message may be decoded, as denoted by steps 310, 312. The decoding engine 214 of the system 200 (wherein now the system is the receiver 104, or Bob) may decode the encoded message received from the sender 102. The decoding process may involve determining the value of θ (step 310), based on which the message M was initially encoded. To this end, the sender 102 may communicate the positions of the qubits of Q_{θ} to the receiver 104. The decoding engine 214 in the receiver 104, on receiving the positions of the qubits of Q_{θ}, may measure the received qubits based on proper bases corresponding to received value of Id_{B}, i.e., if the i-th bit Id_{B} is 0 or 1. If the bit is 0, then the decoding engine 214 of the receiver 104 may elect {|0〉, |1〉} as the basis, whereas if the bit is 1, then the decoding engine 214 may elect {|+〉,|-〉} as the basis for measuring the qubits of Q_{θ}.

The decoding engine 214 may then measure the qubits of Q_{θ} to obtain a value of θi, wherein 1 ≤ i ≤ k′. In an example, the decoding engine 214 within the receiver 104 may determine a decimal representation of θ₁θ₂... θ_{k′} to get the value of θ. It may be noted that since Id_{B} is a secret key, only the receiver 104 (i.e., Bob) can undertake the decoding of the value of θ.

Once the value of θ is obtained, the decoding engine 214 may discard one or more measured qubits and retrieves the sequence Q¹_{A} (since all the qubits of the set (Q⁵_{A} / Q¹_{A}) are already measured in the previous steps. With the value of θ now known, the decoding engine 214 of the receiver 104 may apply the unitary operator U_{θ}⁻¹ to all qubits of Q¹_{A}. As a result of this operation, all the qubits of Q¹_{A} are now in {|0〉, |1〉} basis. At this stage, the decoding engine 214 may measures these qubits in {|0〉, |1〉} basis. If the i-th measurement result is |0〉, then the decoding engine 214 may concludes M′ᵢ = 0, else M′ᵢ = 1. In case of the latter, the decoding engine 214 may decode the classical bit Mᵢ′ of the string M′ (which was introduced in the previous steps), as denoted by step 312.

Next, the decoding engine 214 of the receiver 104 may further check the integrity of the secret message. To this end, the decoding engine 214 may publicly compare the random check bits and calculate the error rate. If the error rate is negligible, then by discarding the check bits (which have the negligible error) from M′, the decoding engine 214 may retrieve the message M. If the error rate is greater than a predefined threshold, the communication session may be terminated.

The above-mentioned approaches, as also discussed briefly above, provide a number of distinct technical advantages. For example, the present approaches have been determined to be very resilient and efficient in averting different types of attacks such an impersonation attack, intercept-and-resend attack, entangle-and-measure attack, DoS attack, man-in-the-middle attack, information leakage attack, and trojan horse attack. Furthermore, the present subject matter also with minimum overhead in a noisy scenario as long as the duration of the ideal channel is below a certain threshold. These and other aspects are further described in conjunction with the following examples and in relation to the different types of attacks that may occur while the sender 102 (i.e., Alice) communicates with the receiver 104 (i.e., Bob).

To explain the concepts and the operation performed by the encoding engine 208, the security engine 210, authentication engine 212 and the decoding engine 214 of the system 200, an example is now discussed. It may be noted that the example is only indicative of one of the many other possible implementation. The same should not be construed as a limitation in any manner. In this current example, Θ = {x° : x is an integer and 1 ≤ x ≤ 8}, and Id_{A} = 1100, Id_{B} = 0111. In the current example, the message M is depicted as ‘011101’. In operation, the encoding engine 208 of the sender 102 may insert check bits 1 and 0 after the 1st and 3rd bits of M, to provide the updated message M′= 01110101. Within the updated message stream M′, the check bits that had been inserted are indicated with an underline. With the updated message stream M′ thus obtained, the encoding engine 208 may generate Q¹_{A} which comprises n′ number of single qubits in {|0〉, |1〉} basis corresponding to M′. Considering the example message stream M′, the Q¹_{A} may be represented as follows:

$${\text{Q}}^{1} {}_{\text{A}} = \left|0\right〉 \left|1\right〉 \left|1\right〉 \left|1\right〉 \left|0\right〉 \left|1\right〉 \left|0\right〉 \left|1\right〉$$

Proceeding further, the encoding engine 208 may select an angle θ = 7° and applies apply a unitary operator U_{θ} on all the qubits of Q¹_{A}, to provide Q¹_{A} as follows:

$$\begin{matrix}{\text{Q}}^{1} {}_{\text{A}} = \left|\text{x}\right〉 \left|\text{y}\right〉 \left|\text{y}\right〉 \left|\text{y}\right〉 \left|\text{x}\right〉 \left|\text{y}\right〉 \left|\text{x}\right〉 \left|\text{y}\right〉 , \text{where} \left|\text{x}\right〉 = {\text{U}}_{θ} \left|0\right〉 \text{and} \\ \left|\text{y}\right〉 = {\text{U}}_{θ} \left|1\right〉\end{matrix}$$

The process proceeds further wherein the encoding engine 208 may further receive a prepared sequence of single qubits I_{A}, wherein I_{A} corresponds to the authentication identity Id_{A} of the sender 102. In an example, the encoding engine 208 may insert qubits of I_{A} into Q¹_{A} to provide a new sequence Q²_{A} wherein which:

$${I}_{A} = \left|-\right〉 \left|0\right〉 a n d {Q}_{A}^{2} = \left|x\right〉 \left|y\right〉 \left|-\right〉 \left|y\right〉 \left|0\right〉 \left|y\right〉 \left|x\right〉 \left|y\right〉 \left|x\right〉 \left|y\right〉 ,$$

wherein where the boxed qubits are randomly added from I_{A}.

The encoding engine 208 may thereafter obtain a sequence I_{B} by choosing a k-bit random number r=1001, with the encoding engine 208 providing a sequence of single qubits corresponding to the bit strings Id¹_{B} and Id_{B}, wherein Id¹_{B}= Id_{B} ⊕ r. With r=1001, the Id¹_{B} may be represented as Id¹_{B}= 0111 ⊕ 1001 = 1110. In this example, the I_{B}= |1〉 |-〉 |-〉 |+〉 and the resulting new sequence Q³_{A} being depicted as follows:

$${Q}_{A}^{3} = \left|x\right〉 \left|1\right〉 \left|y\right〉 \left|-\right〉 \left|-\right〉 \left|y\right〉 \left|0\right〉 \left|y\right〉 \left|-\right〉 \left|x\right〉 \left|y\right〉 \left|x\right〉 \left|+\right〉 \left|y\right〉$$

where the boxed qubits are randomly added from I_{B}.

As explained above, the encoding engine 208 may further encode a value of θ by preparing a sequence of single qubits Q_{θ} which are depicted as follows:

$$\begin{matrix}{\text{Q}}_{θ} = \left|1\right〉 \left|\text{-}\right〉 \left|\text{-}\right〉 \text{and} \\ {Q}_{A}^{4} = \left|x\right〉 \left|1\right〉 \left|y\right〉 \left|-\right〉 \left|-\right〉 \left|y\right〉 \left|1\right〉 \left|0\right〉 \left|-\right〉 \left|y\right〉 \left|-\right〉 \left|x\right〉 \left|y\right〉 \left|-\right〉 \left|x\right〉 \left|+\right〉 \left|y\right〉\end{matrix}$$

where the boxed qubits are randomly added from Q_{θ}. Thereafter, the security engine 210 may select a sequence D_{A} of m number of decoy photons randomly from {|0〉, |1〉, |+〉, |-〉} and inserts them in random positions of Q⁴_{A} to provide Q⁵_{A}, wherein

$$\begin{matrix}D e c o y p h o t o n s {D}_{A} = \left|0\right〉 \left|1\right〉 \left|+\right〉 \left|0\right〉 \text{and} \\ {Q}_{A}^{5} = \left|x\right〉 \left|0\right〉 \left|1\right〉 \left|1\right〉 \left|y\right〉 \left|-\right〉 \left|-\right〉 \left|y\right〉 \left|1\right〉 \left|0\right〉 \left|-\right〉 \left|y\right〉 \left|-\right〉 \left|x\right〉 \left|+\right〉 \left|y\right〉 \left|-\right〉 \left|x\right〉 \left|0\right〉 \left|+\right〉 \left|y\right〉\end{matrix}$$

where the boxed qubits are randomly added from D_{A}.

The above-obtained Q⁵_{A} may then transmitted by the sender 102 (i.e., Alice) to the receiver 104 (i.e., Bob). Once the Q⁵_{A} has been received by the sender, the security engine 210 within the receiver 104 may perform a security check. In an example, after the receiver 104 received the Q⁵_{A} the sender 102 may announce the positions (2^{nd}, 4^{th}, 15^{th} and 19^{th}) and bases ({|0〉, |1〉), {|0〉,|1〉}, {|+〉,|-〉}, {|0〉,|1〉}) of the decoy photons. In this case, the receiver 104 may measure the decoy photons and announce the results (|0〉, |1〉, |+〉, |0〉). Based on the announcement by the receiver 104, the sender 102 (i.e., Alice) may calculate the error in the channel. In case the channel is noiseless, the security engine 210 of the receiver 104 may discard all measured qubits to get back the Q⁴_{A}.

Thereafter, the receiver 104 may perform authentication of the communication received from the sender 102. In an example, the authentication of the received communication may be performed by the authentication engine 212. To this end, the sender 102 (i.e., Alice) may announce the positions (say positions 4^{th} and 8^{th}) of the qubits of I_{A} and the receiver 104 may choose ({|x〉,|y〉}, {|0〉, |1〉}) to measure the qubits. Once the aforementioned bases are selected, the authentication engine 212 may provide |-〉 and |0〉, which is equivalent to Id_{A}. Thereafter, the sender 102 may communicate the positions (2nd, 5th, 11th and 16th) of the single qubits of I_{B}. In response to the communication of said positions, the receiver 104 (i.e., its authentication engine 212) may select the bases ({|0〉, |1〉}, {|+〉, |-〉}, {|+〉, |-〉}, and {|+〉, |-〉}) to measure those qubits and get the |1〉|-〉|-〉|+〉. In an example, the authentication engine 212 may obtain Id¹_{B} = 1110 and may announce r=1110 ⊕ 0111 = 1001. Based on the same, the sender 102 is able to confirm the identity of the receiver 104.

Once the identity of the sender has been ascertained, the encoded message may be decoded. In an example, the sender 102 may communicate the receiver 104 the positions (7th, 9th and 14th) of the qubits of Q_{θ} with the decoding engine 214 of the receiver 104 choosing the bases ({|0〉, |1〉}, {|+〉, |-〉}, {|+〉, |-〉}) to measure the said qubits and obtain θ. Thereafter, the decoding engine 214 of the receiver 104 may discard all the measured qubits to get Q¹_{A} and applies Uθ⁻¹ to all the qubits of Q¹_{A}. Once the same has been applied, the decoding engine 214 of the receiver 104 may measure the aforementioned qubits in {|0〉, |1〉} bases to obtained M′+01110101. In an example, the decoding engine 214 may thereafter publicly compare the random check bits (2nd and 5th bit of M′) with the decoding engine 214 of the receiver 104 discarding those bits to obtain M = 011101 (the communicated message). It may be noted that the present example as been described with respect to the message M and the various basis that had been elected. It may be noted that other combinations are also possible without limiting the scope of the present subject matter.

It may be noted that the current approaches may be utilized against a number of security attacks. Examples of such attacks include, but are not limited to the impersonation attack, intercept-and-resend attack, entangle-and-measure attack, denial-of-Service (DoS) attack, man-in-the-middle attack, information leakage attack, and Trojan horse attack. The approaches as discussed above provide a high probability of detecting an eavesdropping entity by any one of the communicating quantum computing systems, i.e., either the sender 102 or the receiver 104. These aspects are further described in conjunction with the current examples.

### Impersonation Attacks

The current example is described in the context of an eavesdropping device which may be impersonating a legitimate party engaged in a communication. For the present example, the impersonating entity or system is referred to as Eve. The entity Eve may be any quantum computing device that may either be impersonating another quantum computing device, such as the sender 102 (i.e., Alice). In the present example, Eve may impersonate the sender 102 to send an impersonating message to receiver 104, i.e., Bob. In the present case, Eve would not have any knowledge about Id_{A}, but may generate the qubits of I′_{A} randomly from bases {|0〉, |1〉, |x〉, |y〉}. As the receiver 104 is aware of its Id_{A} the receiver 104 may elect the corresponding bases to measure the qubits of I′_{A}. According to the value of the bits Id_{A,(2i-1)},d_{A,2i}, the i-th qubit of I_{A} which us denoted by I_{A,i} prepared in basis B, where B = {|0〉, |1〉} or {|+〉, |-〉}. In the present example, it is possible that Eve will prepare the i-th Eve I′_{A}, _{I} in the B′ basis. Since the receiver 104 would be aware of the exact state of I_{A,} _{I}, the receiver 104 may measure the I′_{A,} _{I} in the B basis. The measurement results, in an example, may be denoted as I″_{A, i}. In such a case, the probability P that the receiver 104 would not be able to detect the eavesdropping, Eve may be denoted by Pr(I″_{A,} ᵢ= I_{A,} ᵢ). With this as the basis, one of the following may apply:
If B = B′ and I_{A,i} = I′_{A,i}, then
$${{I}^{″}}_{A , i} = {I}_{A , i}$$
with probability 1.
If B = B′ and I_{A,i} ≠ I′_{A,i}, then
$${{I}^{″}}_{A , i} = {I}_{A , i}$$
with probability 0.
If B ≠ B′, then
$${{I}^{″}}_{A , i} = {I}_{A , i}$$
with probability ½.

With the above, it may therefore be concluded that for each qubit of I′_{A} the winning probability if Eve may be determined as the eavesdropper, is as follows:

$$\begin{matrix}Pr \left({{I}^{″}}_{A , i} = {I}_{A , i}\right) \\ = Pr \left({{I}^{″}}_{A , i} = {I}_{A , i} \vert B = {B}^{′}\right) Pr \left(B = {B}^{′}\right) + Pr \left({{I}^{″}}_{A , i} = {I}_{A , i} \vert B \neq \right) \\ \left({B}^{′}\right) Pr \left(B \neq {B}^{′}\right) \\ = \frac{1}{2} \left[Pr \left({{I}^{″}}_{A , i} = {I}_{A , i} \vert B = {B}^{′}\right) + Pr \left({{I}^{″}}_{A , i} = {I}_{A , i} \vert B \neq {B}^{′}\right)\right] \\ = \frac{1}{2} \left[Pr \left({{I}^{″}}_{A , i} = {I}_{A , i} \vert B = {B}^{′} , {I}_{A , i} = {{I}^{′}}_{A , i}\right) Pr \left({I}_{A , i} = {{I}^{′}}_{A , i}\right) +\right) \\ \left(Pr \left({{I}^{″}}_{A , i} = {I}_{A , i} \vert B = {B}^{′} , {I}_{A , i} \neq {{I}^{′}}_{A , i}\right) Pr \left({I}_{A , i} \neq {{I}^{′}}_{A , i}\right) + 1 / 2\right] \\ = \frac{1}{2} \left[1 \times \frac{1}{2} + 0 \times \frac{1}{2} + \frac{1}{2}\right] = \frac{1}{2} .\end{matrix}$$

In an example, the above steps may be performed by the authentication engine 212. In an example, the authentication engine 212 may determine the probability that the receiver 104 may be able to detect Eve with probability 1 - (½)^{k}/².

Continuing with the present example, if Eve were to impersonate the receiver 104 (i.e., Bob) to get the secret message from the sender 102, then Eve would have no idea about the preparation bases of the qubits of I_{B}. In such a case, as also discussed previously, Eve would be randomly selecting the basis {|0〉, |1〉}, or {|+〉, |-〉} to measure those qubits. From the measurement results, Eve would have the probability of correctly guesses the value of Id¹_{B} with probability (¾)^{k}. Since Id¹_{B} = Id_{B} ⊕ r and Id_{B} is unknown to Eve, from the security notion since r is completely random to Eve, the probability of Eve being able to correctly guess r is (½)^{k}. Therefore, when Eve announces the random number r, the sender 102 (i.e., Alice) is capable of detecting Eve with probability 1 - (½)^{k} which is quite high. As may be understood, the legitimate party, i.e., the sender 102 is capable of detecting the presence of the impersonating system, i.e., Eve with a probability 1 - (½)^{k} in cases of impersonation attacks.

### Intercept and Resend Attacks

In such attacks, the impersonating system, i.e., Eve may intercept the qubits from the quantum channel being sent from the sender 102, i.e., Alice to receiver 104, i.e., Bob. In such an attack, Eve may measure the qubits and resends the same to the receiver 104. In our proposed protocol, Eve may intercept the sequence Q⁵_{A} (as discussed above in conjunction with FIG. 3) from the quantum channel 106. Note that the qubits corresponding to M′ are encoded in an arbitrary basis {|x〉, |y〉} and those are in random positions of Q⁵_{A}. Continuing with the current example, Eve may choose a random θ₀ ∈ Θ and measure all the qubits in {|x₀〉, |y₀〉} basis, where,

$$\begin{matrix}\left|{x}_{0}\right〉 = {U}_{{θ}_{0}} \left|0\right〉 = cos {θ}_{0} \left|0\right〉 + sin {θ}_{0} \left|1\right〉 \\ = \frac{1}{\sqrt{2}} \left[\left(cos {θ}_{0} + sin {θ}_{0}\right) \left|+\right〉 + \left(cos {θ}_{0} - sin {θ}_{0}\right) \left|-\right〉\right]\end{matrix}$$

and

$$\begin{matrix}\left|{y}_{0}\right〉 = {U}_{{θ}_{0}} \left|1\right〉 = - sin {θ}_{0} \left|0\right〉 + cos {θ}_{0} \left|1\right〉 \\ = \frac{1}{\sqrt{2}} \left[\left(cos {θ}_{0} - sin {θ}_{0}\right) \left|+\right〉 - \left(cos {θ}_{0} + sin {θ}_{0}\right) \left|-\right〉\right] .\end{matrix}$$

Then,

$$\begin{matrix}\left|0\right〉 = cos {θ}_{0} \left|x\right〉 - sin {θ}_{0} \left|y\right〉 , \\ \left|1\right〉 = sin {θ}_{0} \left|x\right〉 + cos {θ}_{0} \left|y\right〉\end{matrix}$$

and

$$\begin{matrix}\left|+\right〉 = \frac{1}{\sqrt{2}} \left[\left(cos {θ}_{0} + sin {θ}_{0}\right) \left|x\right〉 + \left(cos {θ}_{0} - sin {θ}_{0}\right) \left|y\right〉\right] , \\ \left|-\right〉 = \frac{1}{\sqrt{2}} \left[\left(cos {θ}_{0} - sin {θ}_{0}\right) \left|x\right〉 - \left(cos {θ}_{0} + sin {θ}_{0}\right) \left|y\right〉\right] .\end{matrix}$$

It is pertinent to note that Eve’s measurement affects the decoy photons (as discussed in conjunction with FIG. 3). In an example, we may assume that the i-th decoy photon be D_{A,i} prepared in basis B, where B = {|0〉, |1〉} or {|+〉, |-〉}. Once Eve measures the qubits in {|x₀〉, |y₀〉} basis the state becomes D′_{A,i}. In an example, the sender 102, i.e., Alice may announces the preparation basis of D_{A,i} pursuant to which Bob measures D′_{A,i} in basis B and to further obtain D″_{A.i}. To ascertain the probability of detection of Eve, the same may be ascertained by determining the probability that D_{A,i} = D″_{A,i}. In an example, the authentication engine 212 of the sender 102 may determine the probability that D_{A,i} = D″_{A,i}.

The authentication engine 212 may initially determine the impact of Eve’s measurements on the decoy photons for various original states, D_{A,i}. The same are depicted in Table 1 below:

| Original state D_{A,i} | After Eve’s measurement: DJ_{A,i} | | After Bob’s measurement: Dn_{A,i} | |
|---|---|---|---|---|
| | State | Probability | State | Probability |
| \|0〉 | \|x₀〉 | cos² θ₀ | \|0〉 | cos² θ₀ |
| | \|y₀〉 | sin² θ₀ | | sin² θ₀ |
| \|1〉 | \|x₀〉 | sin² θ₀ | \|1〉 | sin² θ₀ |
| | \|y₀〉 | cos² θ₀ | | cos² θ₀ |
| \|+〉 | \|x₀〉 | $\frac{1}{2} {\left(cos {θ}_{0} + sin {θ}_{0}\right)}^{2}$ | \|+〉 | $\frac{1}{2} {\left(cos {θ}_{0} + sin {θ}_{0}\right)}^{2}$ |
| | \|y₀〉 | $\frac{1}{2} {\left(cos {θ}_{0} + sin {θ}_{0}\right)}^{2}$ | | $\frac{1}{2} {\left(cos {θ}_{0} + sin {θ}_{0}\right)}^{2}$ |
| \|-〉 | \|x₀〉 | $\frac{1}{2} {\left(cos {θ}_{0} + sin {θ}_{0}\right)}^{2}$ | \|-〉 | $\frac{1}{2} {\left(cos {θ}_{0} + sin {θ}_{0}\right)}^{2}$ |
| | \|y₀〉 | $\frac{1}{2} {\left(cos {θ}_{0} + sin {θ}_{0}\right)}^{2}$ | | $\frac{1}{2} {\left(cos {θ}_{0} + sin {θ}_{0}\right)}^{2}$ |

Based on the above, the probability that D_{A,i} = D″_{A,i} i.e., Pr (D_{A,i} = D″_{A,i}) may be evaluated as follows:

$$\begin{matrix}\text{Pr} \left({{D}^{″}}_{A , i} = {D}_{A , i}\right) \\ = {\sum }_{\left|b\right〉 ∈ \left\{\left|0\right〉 , \left|1\right〉\right\}} Pr \left({{D}^{″}}_{A , i} = \left|b\right〉 , {D}_{A , i} = \left|b\right〉\right) + {\sum }_{\left|b\right〉 ∈ \left\{\left|+\right〉 , \left|-\right〉\right\}} Pr \left({{D}^{″}}_{A , i} = \left|b\right〉 ,\right) \\ \left({D}_{A , i} = \left|b\right〉\right) \\ = {\sum }_{\left|b\right〉 ∈ \left\{\left|0\right〉 , \left|1\right〉\right\}} Pr \left({{D}^{″}}_{A , i} = \left|b\right〉 \vert {D}_{A , i} = \left|b\right〉\right) Pr \left({D}_{A , i} = \left|b\right〉\right) + \\ {\sum }_{\left|b\right〉 ∈ \left\{\left|+\right〉 , \left|-\right〉\right\}} Pr \left({D}_{A , i} = \left|b\right〉 \vert {{D}^{″}}_{A , i} = \left|b\right〉\right) Pr \left({D}_{A , i} = \left|b\right〉\right) \\ = \frac{1}{4} \left[{\sum }_{\left|b\right〉 ∈ \left\{\left|0\right〉 , \left|1\right〉\right\}} Pr \left({{D}^{″}}_{A , i} = \left|b\right〉 \vert {D}_{A , i} = \left|b\right〉\right) + {\sum }_{\left|b\right〉 ∈ \left\{\left|+\right〉 , \left|-\right〉\right\}} Pr \left({{D}^{″}}_{A , i} =\right)\right) \\ \left(\left(\left|b\right〉 \vert {D}_{A , i} = \left|b\right〉\right)\right] \\ = \frac{1}{4} \left[2 \left({cos}^{4} {θ}_{0} + {sin}^{4} {θ}_{0}\right) + 2 \left\{\frac{1}{4} {\left(cos {θ}_{0} + sin {θ}_{0}\right)}^{4} + \frac{1}{4} \left(cos {θ}_{0} -\right)\right)\right) \\ \left(\left({\left(sin {θ}_{0}\right)}^{4}\right\}\right] \\ = \frac{1}{2} \left[\left({cos}^{4} {θ}_{0} + {sin}^{4} {θ}_{0}\right) + \frac{1}{2} \left(1 + s i {n}^{2} 2 {θ}_{0}\right)\right] \\ = \frac{1}{2} {\left(s i {n}^{2} {θ}_{0} + c o {s}^{2} {θ}_{0}\right)}^{2} + \frac{1}{4} = \frac{3}{4} .\end{matrix}$$

Thus, the probability that the sender 102 and the receiver 104 may determine the present of the impersonating system, Eve, is 1 - (¾)^{m}, where m is the number of decoy photons. In the example as discussed, one of the legitimate parties, say, sender 102 (Alice) may detect presence of Eve and terminates the communication protocol.

In the example as discussed, the probability of Eve detecting the original message is also low. In an example, the probability that Eve can detect or guess the original may be represented as:

$${p}_{c o r r} = \frac{1}{N \times \left({}_{n}^{l}\right)} .$$

For positive integers n and l with 1 ≤ n ≤ l, we know that,

$${\left(\frac{l}{n}\right)}^{n} \leq \left(\begin{matrix}l \\ n\end{matrix}\right) ,$$

which implies

$${p}_{c o r r} \leq \frac{1}{N} {\left(\frac{n}{l}\right)}^{n} \text{} \leq {\left(\frac{1}{2}\right)}^{\left⌊l o {g}_{2} N\right⌋} \times {\left(\frac{n}{l}\right)}^{n} \text{} \leq {\left(\frac{1}{2}\right)}^{n} , \text{if} l \geq 2 n {\left(\frac{1}{2}\right)}^{\left⌊l o {g}_{2} N\right⌋ / n} ,$$

where

$$\left⌊l o {g}_{2} N\right⌋ / n$$

denotes the greatest integer less than or equal to log₂N. With this, the probability of Eve correctly guessing the messages would be

$${p}_{c o r r} \leq {\left(\frac{1}{2}\right)}^{n}$$

if

$$l \geq 2 n {\left(\frac{1}{2}\right)}^{8 / n} .$$

Based on the different values of n, it is clear that the probability of Eve correctly guessing the messages is negligible. Thus, it may be gathered that the present approaches provide a resilient mechanism against Intercept and Resend Attacks.

### Entangle-and-Measure Attack

In such types of attacks, the impersonating system, i.e., Eve, may obtain partial information about the message M. For this purpose, Eve prepares a set of ancilla qubits who initial state may be depicted as

$${\left|χ\right〉}_{e} .$$

When the sender 102, i.e., Alice shares Q⁵_{A} with the receiver 104, i.e., Bob, Eve may perform a unitary operation Uₑ on the qubits Q⁵_{A} and

$${\left|χ\right〉}_{e}$$

to make them entangled, where the unitary operation Uₑ is defined as follows:

$${U}_{e} \left|0\right〉 {\left|χ\right〉}_{e} = {α}_{0} \left|0\right〉 {\left|{χ}_{00}\right〉}_{e} + {β}_{0} \left|1\right〉 {\left|{χ}_{01}\right〉}_{e} ,$$

$${U}_{e} \left|1\right〉 {\left|χ\right〉}_{e} = {α}_{1} \left|0\right〉 {\left|{χ}_{10}\right〉}_{e} + {β}_{1} \left|1\right〉 {\left|{χ}_{11}\right〉}_{e} ,$$

Wherein the four pure states

$${\left|{χ}_{00}\right〉}_{e} , {\left|{χ}_{01}\right〉}_{e} , {\left|{χ}_{10}\right〉}_{e}$$

and

$${\left|{χ}_{11}\right〉}_{e}$$

are orthonormal belonging to the Hilbert space corresponding to that of the impersonating system, i.e., Eve. The states in turn may be uniquely determined by the unitary operation Uₑ and the following conditions which may apply:

$${\left|{α}_{0}\right|}^{2} + {\left|{β}_{0}\right|}^{2} = 1 , {\left|{α}_{1}\right|}^{2} + {\left|{β}_{1}\right|}^{2} = 1 ,$$

$${\left|{α}_{0}\right|}^{2} = {\left|{β}_{1}\right|}^{2} = F \text{,} {\left|{α}_{1}\right|}^{2} = {\left|{β}_{0}\right|}^{2} = D .$$

In relation to the above, if the sender 102, i.e., Alice, send

$$\left|\text{b}\right〉 ,$$

where b is from {0,1} then after measurement Bob gets the correct result with probability F. In the current example, F denotes the fidelity and D depicts the quantum bit error rate (QBER) as follows:

$$\begin{matrix}{U}_{e} \left|+\right〉 {\left|χ\right〉}_{e} = \frac{1}{\sqrt{2}} \left({U}_{e} \left|0\right〉 {\left|χ\right〉}_{e} + {U}_{e} \left|1\right〉 {\left|χ\right〉}_{e}\right) \\ = \frac{1}{\sqrt{2}} \left[{α}_{0} \left|0\right〉 {\left|{χ}_{00}\right〉}_{e} + {β}_{0} \left|1\right〉 {\left|{χ}_{01}\right〉}_{e} + {α}_{1} \left|0\right〉 {\left|{χ}_{10}\right〉}_{e} +\right) \\ \left({β}_{1} \left|0\right〉 {\left|{χ}_{11}\right〉}_{e}\right] \\ = \frac{1}{\sqrt{2}} \left[\left|+\right〉 \left({α}_{0} {\left|{χ}_{00}\right〉}_{e} + {β}_{0} {\left|{χ}_{01}\right〉}_{e} + {α}_{1} {\left|{χ}_{10}\right〉}_{e} +\right)\right) \\ \left({β}_{1} {\left|{χ}_{11}\right〉}_{e}\right) / \sqrt{2} + \left|-\right〉 \left({α}_{0} {\left|{χ}_{00}\right〉}_{e} - {β}_{0} {\left|{χ}_{01}\right〉}_{e} + {α}_{1} {\left|{χ}_{10}\right〉}_{e} -\right) \\ \left(\left(- {β}_{1} {\left|{χ}_{11}\right〉}_{e}\right) / \sqrt{2}\right] \\ = \frac{1}{\sqrt{2}} \left(\left|+\right〉 {\left|{χ}_{+ +}\right〉}_{e} + \left|-\right〉 {\left|{χ}_{+ -}\right〉}_{e}\right)\end{matrix}$$

And

$$\begin{matrix}{U}_{e} \left|-\right〉 {\left|\text{χ}\right〉}_{e} = \frac{1}{\sqrt{2}} \left({U}_{e} \left|0\right〉 {\left|\text{χ}\right〉}_{e} - {U}_{e} \left|1\right〉 {\left|\text{χ}\right〉}_{e}\right) \\ = \frac{1}{\sqrt{2}} {\left[{α}_{0} \left|0\right〉 {\left|{\text{χ}}_{00}\right〉}_{e} + {β}_{0} \left|1\right〉 \left|{\text{χ}}_{01}\right〉\right)}_{e} - \\ \left({α}_{1} \left|0\right〉 {\left|{\text{χ}}_{10}\right〉}_{e} - {β}_{1} \left|1\right〉 {\left|{\text{χ}}_{11}\right〉}_{e}\right] \\ = \frac{1}{\sqrt{2}} \left[\left|+\right〉 \left({α}_{0} {\left|{\text{χ}}_{00}\right〉}_{e} + {β}_{0} {\left|{\text{χ}}_{01}\right〉}_{e} - {α}_{1} {\left|{\text{χ}}_{10}\right〉}_{e} -\right)\right) \\ {β}_{1} {\left|{\text{χ}}_{11}\right〉}_{e} / \sqrt{2} + \left|-\right〉 \left({α}_{0} {\left|{\text{χ}}_{00}\right〉}_{e} - {β}_{0} {\left|{\text{χ}}_{01}\right〉}_{e} - {α}_{1} {\left|{\text{χ}}_{10}\right〉}_{e} +\right) \\ \left(\left({β}_{1} {\left|{\text{χ}}_{11}\right〉}_{e}\right) / \sqrt{2}\right] \\ = \frac{1}{\sqrt{2}} \left(\left|+\right〉 {\left|{\text{χ}}_{- +}\right〉}_{e} + \left|-\right〉 {\left|{\text{χ}}_{- -}\right〉}_{e}\right) .\end{matrix}$$

In line with the above example, let us assume that the sender 102, i.e., Alice, sends

$$\left|\text{b}\right〉$$

, wherein b belongs to {+,-}, then after measurement, the receiver 104 will get the correct result with probability, ½.

Now as per the approaches implemented by the sender 102 or the receiver 104, the sender 102 may obtain one or more decoy states from randomly

$$\left\{\left|0\right〉 , \left|1\right〉 , \left|+\right〉 , \left|\text{-}\right〉\right\} .$$

Continuing further, for a particular decoy state

$$\left|\text{b}\right〉$$

the receiver 104 may obtain the correct state with probability depicted as:

$$p = \frac{1}{2} \left(F + 1 / 2\right)$$

wherein F denotes the fidelity when the decoy state is in

$$\left\{\left|0\right〉 , \left|1\right〉\right\}$$

and ½ fidelity when the decoy state is in

$$\left\{\left|+\right〉 , \left|\text{-}\right〉\right\} .$$

It is pertinent to note that both the cases as discussed occur with the probability ½. Therefore, the security engine 210, say of the sender 102 and the receiver 104, while performing the security check would be in a position to detect the present of Eve. The probability of detecting Eve, may be represented as 1-p^{m} wherein m is the number of decoy states.

It may also be noted that even when the current attack is employed, the current approach still limits the extent to which the Eve may derive the message M. In an example, considering the unitary operation applied on the qubits of Q⁵_{A}, the following may be derived:

$$\begin{matrix}{U}_{e} \left|x\right〉 {\left|\text{χ}\right〉}_{e} = {U}_{e} \left(c o s θ \left|0\right〉 + sin θ \left|1\right〉\right) {\left|\text{χ}\right〉}_{e} \\ = \left|0\right〉 \left({α}_{0} cos θ {\left|{\text{χ}}_{00}\right〉}_{e} + {α}_{1} sin θ {\left|{\text{χ}}_{10}\right〉}_{e}\right) + \\ \left|1\right〉 \left({β}_{0} cos θ {\left|{\text{χ}}_{01}\right〉}_{e} + {β}_{1} sin θ {\left|{\text{χ}}_{11}\right〉}_{e}\right) \\ = \left(cos θ \left|x\right〉 - sin θ \left|y\right〉\right) \left({α}_{0} cos θ {\left|{\text{χ}}_{00}\right〉}_{e} + {α}_{1} sin θ {\left|{\text{χ}}_{10}\right〉}_{e}\right) + \\ \left(sin θ \left|x\right〉 + cos θ \left|y\right〉\right) \left({β}_{0} cos θ {\left|{\text{χ}}_{01}\right〉}_{e} + {β}_{1} sin θ {\left|{\text{χ}}_{11}\right〉}_{e}\right)\end{matrix}$$

And

$$\begin{matrix}{U}_{e} \left|y\right〉 {\left|\text{χ}\right〉}_{e} = {U}_{e} \left(- sin θ \left|0\right〉 + cos θ \left|1\right〉\right) {\left|\text{χ}\right〉}_{e} \\ = \left|0\right〉 \left(- {α}_{0} sin θ {\left|{\text{χ}}_{00}\right〉}_{e} + {α}_{1} cos θ {\left|{\text{χ}}_{10}\right〉}_{e}\right) + \\ \left|1\right〉 \left(- {β}_{0} sin θ {\left|{\text{χ}}_{01}\right〉}_{e} + {β}_{1} cos θ {\left|{\text{χ}}_{11}\right〉}_{e}\right) \\ = \left(cos θ \left|x\right〉 - sin θ \left|y\right〉\right) \left(- {α}_{0} sin θ {\left|{\text{χ}}_{00}\right〉}_{e} + {α}_{1} cos θ {\left|{\text{χ}}_{10}\right〉}_{e}\right) + \\ \left(sin θ \left|x\right〉 + cos θ \left|y\right〉\right) \left(- {β}_{0} sin θ {\left|{\text{χ}}_{01}\right〉}_{e} + {β}_{1} cos θ {\left|{\text{χ}}_{11}\right〉}_{e}\right) .\end{matrix}$$

From the above it may be concluded that the Eve would not derive any useful information by measuring the ancilla qubits which are entangled with the corresponding to the secret message M.

### Denial of Service (DoS) Attack

DoS would entail an impersonating entity, i.e., Eve, to tamper with the original message M. To this end, Eve may intercept the qubits from the quantum channel and randomly applies I and U with probability ½, where U is a random unitary operator. Since Eve would not know the positions of the decoy state, the unitary operation also affects those qubits. As may be understood, Pauli matrices I, σₓ, iσ_{y} and σ_{z} may be considered as to form a basis for the space of all 2×2 Hermitian matrices. Therefore, the unitary matrix U can be represented as a linear combination of the Pauli matrices, as follows:

$$U = {w}_{1} I + {w}_{2} {σ}_{x} + i {w}_{3} {σ}_{y} + {w}_{4} {σ}_{z}$$

Since U is unitary, the sum of all coefficients, i.e.,

$${\sum }_{i = 1}^{4} {w}_{i}^{2} = 1$$

(with the assumption that all coefficients are real values). To calculate the probability of Eve to succeed, it may be pertinent to describe the effects of the Pauli operators on the decoy qubits. Where I an identity operator is applied on qubits, it does not alter the state of the qubits. Hence, if Eve is to apply I on the decoy state, then after measurements, the receiver 104 would get the correct result. With respect to other Pauli matrices, the following may be evident:

$${σ}_{x} \left|0\right〉 = \left|1\right〉 , {σ}_{x} \left|1\right〉 = \left|0\right〉 , {σ}_{x} \left|+\right〉 = \left|+\right〉 , {σ}_{x} \left|-\right〉 = - \left|-\right〉$$

Based on the above, it may be gathered that if Eve is to apply σₓ then after the measurement, the receiver 104 is to get the correct result with probability ½ as σₓ changes the state of the decoy qubit

$$\left|\text{d}\right〉$$

only if

$$\left|\text{d}\right〉$$

is in

$$\left\{\left|0\right〉 , \left|1\right〉\right\} .$$

In a similar manner, for iσ_{y} and σ_{z} the following may be pertinent to note:

$$\begin{matrix}i {σ}_{y} \left|0\right〉 = - \left|1\right〉 , i {σ}_{y} \left|1\right〉 = \left|0\right〉 , i {σ}_{y} \left|+\right〉 = \left|-\right〉 , i {σ}_{y} \left|-\right〉 = - \left|+\right〉 \text{and} \\ {σ}_{z} \left|0\right〉 = \left|0\right〉 , {σ}_{z} \left|1\right〉 = - \left|1\right〉 , {σ}_{z} \left|+\right〉 = \left|-\right〉 , {σ}_{z} \left|-\right〉 = \left|+\right〉\end{matrix}$$

Based on the above, it may be gathered that if one of iσ_{y} and σ_{z} are applied to the decoy state, then after measurement, the receiver 104 get the correct result with probability 0 and ½, respectively. In such a case, even if Eve is to apply a U on the decoy qubits, the probability for Eve to get the correct result is depicted by:

$${p}^{′} = {\sum }_{i = 1}^{4} {p}_{i} {w}_{i}^{2} < \text{as} U \neq I .$$

In the above circumstances, if Eve elects I and U with probability ½ and the probability that the receiver 104 gets the correct result is

$${p}^{″} = \left(1 + {p}^{′}\right) / 2 .$$

With this as the case, the security engine 210 of either the sender 102 or the receiver 104 is capable of detecting the Eve with the probability, 1-p″^{m}>0, where m is the number of decoy states.

### Man in the Middle (MoM) Attack

In the event that Eve follows a MoM attack strategy, Eve may intercept the sequence Q⁵_{A} from the quantum channel and retain the same. Thereafter, Eve may prepare another set Q_{E} of single qubit states and sends Q_{E} to the receiver 104 (i.e., Bob) instead of Q⁵_{A}. Since Eve does not know the position and exact states of the decoy qubits, the impersonating system may prepare all the single qubits in

$$\left\{\left|0\right〉 , \left|1\right〉\right\}$$

and

$$\left\{\left|+\right〉 , \left|\text{-}\right〉\right\}$$

bases to reduce the detection probability during the security checkup process implemented by the security engine 210 of either the sender 102 or the receiver 104.

In the current example, let the i-th decoy photon be D_{A,i} which is the j-th qubit of the sequence Q⁵_{A} prepared in basis B. It may further be assumed that the j-th qubit of Q_{E} be D′_{A,i} prepared in basis B′, where B and B′ are

$$\left\{\left|0\right〉 , \left|1\right〉\right\}$$

and

$$\left\{\left|+\right〉 , \left|\text{-}\right〉\right\} .$$

In the security check process when the sender 102 may announce the preparation basis of D_{A,i,} then the receiver 104 may measure D′_{A,i} in the basis B and may obtain D″_{A,i}. In such a case, the probability that D″_{A,i} = D_{A,i} may be represented as follows:
If B = B′ and D_{A,i} = D′_{A,i}, then D″_{A,i} = D_{A,i} with probability 1.
If B= B′ and D_{A,i} ≠ D′_{A,i}, then D″_{A,i} = D_{A,i} with probability 0.
If B ≠ B′, then D″_{A,i} = D_{A,i} with probability ½.

In relation to the above, it may be gathered that the probability for Eve to succeed may be derived as follows:

$$\begin{matrix}Pr \left({{D}^{″}}_{A , i} = {D}_{A , i}\right) \\ = Pr \left({{D}^{″}}_{A , i} = {D}_{A , i} \left|B = {B}^{′}\right)\right) Pr \left(B = {B}^{′}\right) + \\ Pr \left({{D}^{″}}_{A , i} = {D}_{A , i} \left|B \neq {B}^{′}\right)\right) Pr \left(B \neq {B}^{′}\right) \\ = \frac{1}{2} \left[Pr \left({{D}^{″}}_{A , i} = {D}_{A , i} \left|B = {B}^{′}\right)\right) + Pr \left({{D}^{″}}_{A , i} = {D}_{A , i} \left|B \neq {B}^{′}\right)\right)\right] \\ = \frac{1}{2} \left[Pr \left({{D}^{″}}_{A , i} = {D}_{A , i} \left|B = {B}^{′} , {D}_{A , i}\right)\right) Pr \left({D}_{A , i} = {{D}^{′}}_{A , i}\right)\right) + \\ \left(Pr \left({{D}^{″}}_{A , i} = {D}_{A , i} \left|B = {B}^{′} , {D}_{A , i} \neq {{D}^{′}}_{A , i}\right)\right) Pr \left({D}_{A , i} \neq {{D}^{′}}_{A , i}\right) + 1 / 2\right] \\ = \frac{1}{2} \left[1 \times \frac{1}{2} + 0 \times \frac{1}{2} + \frac{1}{2}\right] = \frac{1}{2} .\end{matrix}$$

Based on the above, it may be gathered that the sender 102 and the receiver 104 can detect Eve eavesdropping and terminate the protocol with probability 1 - 2^{-m} where m is the number of decoy states. Furthermore, since Eve has no idea about the value of the parameter θ (as discussed in conjunction with FIG. 3) as Id_{B} is a secret key, which only the receiver 104 is aware of, and which only receiver 104 can decode the value of θ. It is also submitted that only the receiver 104 is capable of knowing the exact position of the qubits corresponding to the secret message M. In such a case, without the message M the Eve would not be in a position to get any useful information based on only the Q⁵_{A} using some random basis.

### Information Leakages Attack

In such an attack, the information about the secret message M obtained by analyzing the classical channels (and not the quantum channel 106) by Eve. In other words, it is a measure of the information which Eve can get from the classical channel. Since in the present protocol, no measurement outcome corresponding to the secret bits is discussed by the classical channel, therefore any impersonating system would not be in a position to get any secret information from the communications in the classical channel.

### Trojan Horse Attacks

In the quantum communication approaches as discussed above the sender 102, i.e., Alice, prepares all the qubits required for secure communication, which may then be communicated to the receiver 104, i.e., Bob. As would be understood, such approaches involve a one-way quantum communication protocol. To this end, such approaches are resilient to any attempts by an impersonating system, i.e., Eve to adopt the Trojan horse attack strategy to get any information about message M.

As may be understood, the communication protocol to be adopted between the sender 102 and the receiver 104 has been discussed with respect to its handling of different types of attacks. As discussed, either the sender 102 or the receiver 104 can detect the presence of Eve with a non-negligible probability.

As discussed, the sender 102 and/or the receiver 104 may be implemented in a variety of quantum computing devices. For example, the above-discussed approaches may be implemented on an IBM® Quantum Computer (Armonk device). For such implementation, different lengths of the quantum channel (i.e., various values of the scalar n) may be used. The same may use different values of θ. As will be discussed in the current implementation, the communication between the sender 102 and the receiver 104 is robust against various sources of errors and the integrity of the protocol can be guaranteed with minimum overhead in a noisy scenario as long as the time duration of the ideal channel (i.e., the value of n) is below a certain threshold.

To account for the imperfection of the channel, an error correction may be introduced. In an example, a 3-bit repetition code is provided as an error correction. In an example, the error corrected is a single bit flip error. The use of 3-bit repetition code ensures that to send N qubits through a noisy channel, a total of 3N qubits are sufficient for error-free transmission as long as the error probability is below a particular threshold.

The proposed communication protocol with user authentication using single qubit states (without entanglement) prepared on a fixed but randomly chosen basis. The communication protocol also is secure against various attacks by an eavesdropper intending to get the secret message. These approaches may also be implemented in single qubit device (e.g., IBM® Quantum Computer or Armonk device).

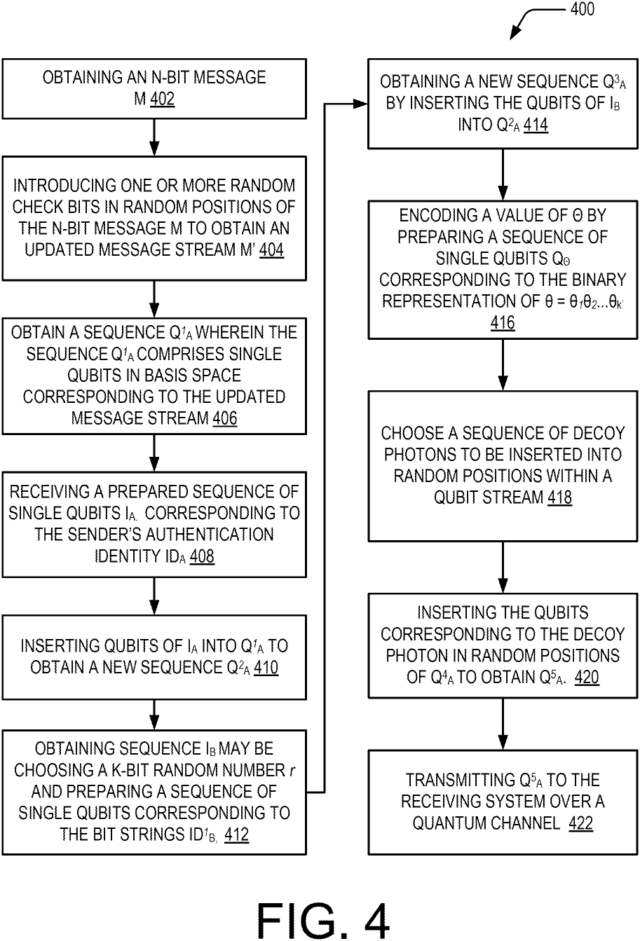

FIG. 4 illustrates a method 400 for encoding a message M which is to be transmitted by the sender 102 to the receiver 104 as part of implementing quantum secure direct communication based on a single orthogonal basis. These and other methods may be implemented in the context of sender 102 and the receiver 104, wherein both the sender 102 and the receiver 104 are quantum computing systems, as per one example. The sender 102 and the receiver 104 may be communicating the message M over a quantum communication channel, such as the quantum communication channel. The order in which the above-mentioned methods are described is not intended to be construed as a limitation, and some of the described method blocks may be combined in a different order to implement the methods, or alternative methods. Furthermore, the above-mentioned methods may be implemented in any suitable hardware, computer-readable instructions, or combination thereof. The steps of these methods may be performed by either a system under the instruction of machine executable instructions stored on a non-transitory computer readable medium or by dedicated hardware circuits, microcontrollers, or logic circuits. For example, the method 400 may be performed by the system 202 within the environment 200. Herein, some examples are also intended to cover non-transitory computer readable medium, for example, digital data storage media, which are computer readable and encode computer-executable instructions, where said instructions perform some or all of the steps of the above-mentioned method.

At block 402, an n-bit message M may be obtained. In an example, the n-bit message M may be obtained by the sender 102 for it to be communicated to a receiver 104.

At block 404, one or more random check bits may be introduced in random positions of the n-bit message M to obtain an updated message stream M′. For example, the encoding engine 208 (of the sender 102, i.e., Alice) may insert or encode one or more random check bits in random positions of the n-bit message M which is to be sent to receiver 104. The updated message stream may be denoted as M′, which includes n′ = n + c bits, where c is the number of check bits that have been introduced by the encoding engine 208.

At block 406, a sequence Q¹_{A} may be obtained wherein the sequence Q¹_{A} comprises single qubits in basis space corresponding to the updated message stream. For example, the encoding engine 208 may further obtain a sequence Q¹_{A} wherein which the sequence Q¹_{A} comprises n′ number of single qubits in

$$\left\{\left|0\right〉 , \left|1\right〉\right\}$$

basis corresponding to M′. It may be noted that the

$$\left|0\right〉 , \left|1\right〉$$

correspond to message bit 0 and 1, respectively. Thereafter, the encoding engine 208 may select an angle θ ∈ Θ and may apply a unitary operator denoted by the operator U_{θ} on all the qubits of Q¹_{A}. Thus, all the qubits of Q¹_{A} which may now be in

$$\left\{\left|\text{x}\right〉 , \left|\text{y}\right〉\right\}$$

basis.

At block 408, a sequence of single qubits I_{A} corresponding to the sender’s authentication identity Id_{A} may be obtained. For example, the encoding engine 208 may further receive a prepared sequence of single qubits I_{A}, wherein I_{A} corresponds to the authentication identity Id_{A} of the sender 102 (i.e., Alice’s). In an example, for 1 ≤ i ≤ k/2 (with k being an even number), the encoding engine 208 may elect the i-th qubit of I_{A} as

$$\left|0\right〉 , \left|1\right〉$$

and

$$\begin{matrix}\left|+\right〉 = \frac{1}{\sqrt{2}} \left(\left|0\right〉 + \left|1\right〉\right) \text{and} \\ \left|-\right〉 = \frac{1}{\sqrt{2}} \left(\left|0\right〉 - \left|1\right〉\right)\end{matrix}$$

according to the values 00,01,10 and 11 of the (2i-1)-th and the 2i-th bits of Id_{A}.

At block 410, the qubits of I_{A} may be inserted into Q¹_{A} to provide a new sequence Q²_{A}. For example, the encoding engine 208 may insert qubits of I_{A} into Q¹_{A} to provide a new sequence Q²_{A}. In an example, the Q²_{A} may include n′ + k/2 number of qubits.

At block 412, another sequence of single qubits I_{B} may be obtained. In an example, the sequence I_{B} may be obtained by choosing a k-bit random number r, with the encoding engine 208 providing a sequence of single qubits corresponding to the bit strings Id¹_{B} and Id_{B}, wherein Id¹_{B} = Id_{B} ⊕ r. In this case, for 1 ≤ i ≤ k, the i-th bit of IdB (Id¹_{B}) may be considered as Id_{B,i} (Id¹_{B,i}), for the following conditions:
i. if
$$\left(I {d}_{B , i}^{1}\right| = 0 \left(1\right)$$
and Id_{B,i} = 0, then the i-th qubit of I_{B} is
$$\left|0\right〉 \left(\left|1\right〉\right) ,$$
ii. if
$$\left(I {d}_{B , i}^{1}\right| = 0 \left(1\right)$$
and Id_{B,i} = 1, then the i-th qubit of I_{B} is
$$\left|+\right〉 \left(\left|-\right〉\right) .$$

At block 414, a new sequence of Q³_{A} may be obtained by inserting the qubits of I_{B} into Q²_{A}. For example, the encoding engine 208 may obtain a new sequence of Q³_{A} by inserting the qubits of I_{B} into Q²_{A}, which may include n′ + 3k/2 number of qubits.

At block 416, a value of θ may be encoded by preparing a sequence of single qubits Q_{θ} corresponding to the binary representation of θ = θ₁θ₂...θk′. For example, the encoding engine 208 may further encode a value of θ by preparing a sequence of single qubits Q_{θ} corresponding to the binary representation of θ = θ₁θ₂...θ_{k′} containing k′ bits. It may be noted that since θ is an integer, whose value lies between 0 to 360, the value of k′ may be ‘9’. For purposes of the present example, for k ≥ k′, the encoding strategy, for 1 ≤ i ≤ k′, may be represented as follows:
i. if θᵢ = 0 (1) and Id_{B,i} = 0, then prepares
$$\left|0\right〉 \left(\left|1\right〉\right) ,$$
ii. if θᵢ = 0 (1) and Id_{B,i} = 1, then prepares
$$\left|+\right〉 \left(\left|-\right〉\right) .$$
Once obtained, the sequence of single qubits Q_{θ} the encoding engine 208 may insert the single qubits in random positions in the Q³_{A} to provide Q⁴_{A}. It may be noted that the above-mentioned encoding strategy adopted by the encoding engine 208 is only indicative.

At block 418, a sequence of decoy photons to be inserted into random positions within a qubit stream may be chosen. For example, the sender 102 (i.e., Alice) may further choose a sequence of decoy photons to be inserted into random positions within a qubit stream. In this example, the security engine 210 may select a sequence D_{A} of m number of decoy photons randomly from

$$\left\{\left|0\right〉 , \left|1\right〉 , \left|+\right〉 , \left|-\right〉\right\} .$$

At block 420, the sequence of the number of decoy photons once obtained and inserts them in random positions of Q⁴_{A} to obtain Q⁵_{A}. Once obtained, at block 422, the sender 102 may transmit the Q⁵_{A} to the receiver 104. In an example, the Q⁵_{A} may be communicated via a quantum communication channel, for example, the quantum communication channel 106.

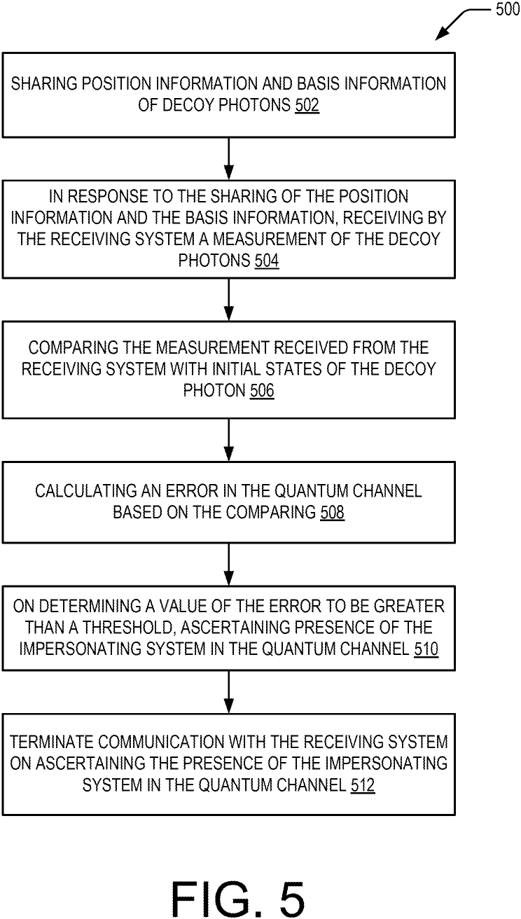

Once the Q⁵_{A} (i.e., the encoded sequence which corresponds to the message M) has been transmitted to the receiver 104, few other additional steps may be implemented. Such steps include functions such as security, authentication and eventually decoding of the encoded sequence, based on which the message M may be retrieved. These aspects are further described in conjunction with various method steps illustrated in FIGS. 5-7.

FIG. 5 illustrates a method 500 for performing a security check as part of implementing quantum secure direct communication based on a single orthogonal basis. At block 502, position information and basis information of decoy photons may be shared by the sender to the receiver. For example, once the Q⁵_{A} has been transmitted, the receiver 104 (i.e., Bob) may receive the sequence Q⁵_{A}. To this end, may announce the positions and bases of the decoy photons.

At block 504, in response to the sharing of the position information and the basis information, the measurement of the decoy photons may be received from the receiver. For example, a security engine (similar to the security engine 210) in the receiver 104 (i.e., Bob) may measure the decoy photons and accordingly communicate the results to Alice.

At block 506, the measurement received from the receiving system with initial states of the decoy photon may be compared. For example, on receiving the measurements from the receiver 104, the security engine 210 within the sender 102, i.e., Alice, may compare the measurement results and the initial states of the decoy photons communicated by the receiver 104, to determine presence of any error in the quantum communication channel 106.

At block 508, calculate an error in the quantum channel based on the comparing. For example, the value of the error may be greater than or less than a threshold value. In case where the value of the error is greater than a predefined threshold, it may indicate the presence of an impersonating system, i.e., Eve. If not, then it may ascertained that the channel is free from any eavesdropping.

At block 510, on determining a value of the error to be greater than a threshold, presence of the impersonating system in the quantum channel may be ascertained. For example, the security engine 210 may compare the determined value of error with a predefined threshold. On determining the error to be greater than the predefined threshold, the security engine 210 may conclude that an impersonating system, i.e., Eve, may be eavesdropping on the quantum channel, such as the quantum channel 106.

At block 512, the communication with the receiving system on ascertaining the presence of the impersonating system in the quantum channel may be terminated. For example, on determining the error to be greater than the predefined threshold, it may be concluded that an impersonating system is eavesdropping on quantum channel 106 and may proceed to terminate the communication session between the sender 102 and the receiver 104.

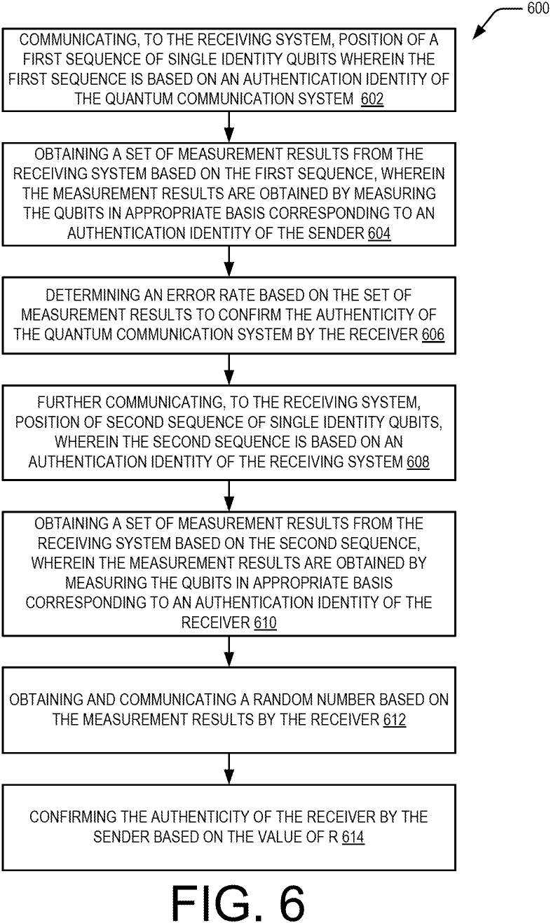

FIG. 6 illustrates a method 600 for performing an authentication of the identity of any one of the party by the other. In an example, the authentication engine 212 may further authenticate and confirm the identity of the receiver 104 (i.e., Bob). At block 602, position of qubits in a first sequence of single identity qubits may be communicated to the receiving system. The first sequence is based on an authentication identity of the sender 102. In an example, the authentication engine 212 of the sender 102 may communicate positions of the single qubits of I_{A}.

At block 604, a set of measurement results may be obtained by the receiver. For example, the positions of the single qubits upon being received, may be measured by Bob (e.g., by the authentication engine 212 in the receiver 104) in proper bases corresponding to Id_{A}. In an example, the receiver 104 may choose

$$\left\{\left|0\right〉 , \left|1\right〉\right\}$$

as the basis if the corresponding bits of Id_{A} are 00 or 01. In another instance, receiver 104 may elect

$$\left\{\left|+\right〉 , \left|-\right〉\right\}$$

as the basis if the corresponding bits of Id_{A} are 10 or 11.

At block 606, an error rate based on the measurement set may be determined. In an example, the receiver 104 may compare the measurement results with the bits of the authentication identity of the sender 102, i.e., Id_{A}. Based on the comparison, the authentication engine 212 of the receiver 104 may determine an error rate. A low error rate implies that there is no eavesdropper, such as Eve, impersonating the sender 102, thereby authenticating the identity of the sender 102. If, however, the error rate is greater than a predefined value, the communication session between the sender 102 and the receiver 104 may be terminated.

Continuing further, to authenticate the identity of the receiver 104, at block 608, position of qubits in second sequence of single identity qubits may be communicated to the receiving system. In an example, the second sequence is based on an authentication identity of the receiver 104. In an example, the authentication engine 212 of the sender 102 may communicate positions of the single qubits of I_{B}.

At block 610, a set of measurement results may be obtained by the receiver based on the position of the qubits of the second sequence, i.e., I_{B} may be measured by Bob (e.g., by the authentication engine 212 in the receiver 104) in proper bases corresponding to Id_{B}.

At block 612, a random number is obtained and communicated to the sender based on the measurements performed by receiver. For example, the authentication engine 212 of the receiver 104 may determine a random number r which may then be communicated to the sender 102.

At block 614, the sender may, using the random number r, may authenticate the identity of the receiver. For example, the authentication engine 212 of the sender 102 may utilize the random number r to affirm the authenticity of the receiver 104. Based on the same, the sender 102 may either continue with the communication or terminate the communication with the receiver 104.

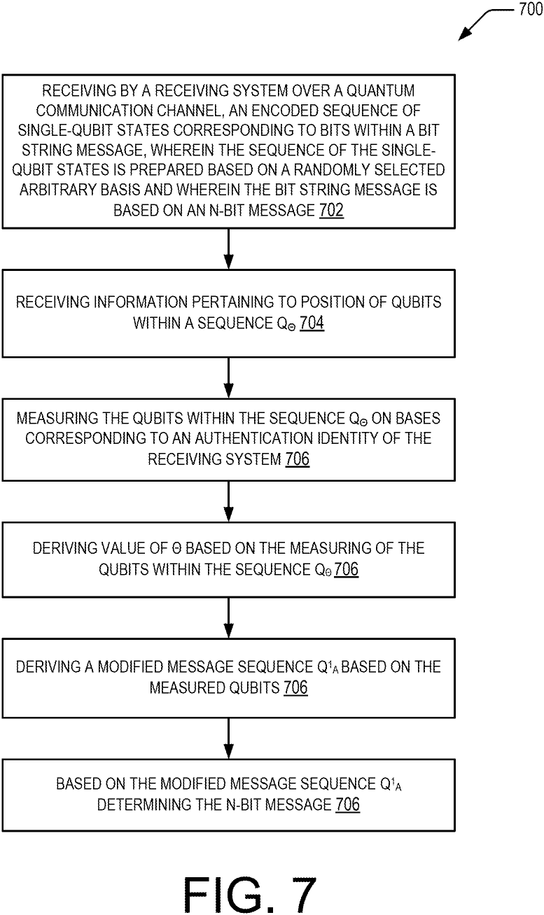

FIG. 7 illustrates a method 700 for decoding the encoded message that may be received as part of implementing quantum secure direct communication based on a single orthogonal basis. In the example as discussed, the decoding engine 214 within the receiver 104, or Bob, may decode the encoded message received from the sender 102. At block 702, an encoded sequence of single-qubit states corresponding to bits within a bit string message may be received a receiving system or a receiver. The sequence of the single-qubit states is such that it is prepared based on a randomly selected arbitrary basis and wherein the bit string message is based on an n-bit message.

At block 704, information pertaining to position of qubits within a sequence Q_{θ} may be received from a transmitting system. In an example, the sender 102 may communicate the positions of the qubits of Q_{θ} which may be received by the decoding engine 214 of the receiver 104.

At block 706, the qubits within the sequence Q_{θ} may be measured using bases corresponding to an authentication identity of the receiving system. For example, the decoding engine 214 of the receiver 104 may measure the received qubits based on proper bases corresponding to received value of Id_{B}, i.e., if the i-th bit Id_{B} is 0 or 1. If the bit is 0, then the decoding engine 214 may elect

$$\left\{\left|0\right〉 , \left|1\right〉\right\}$$

as the basis, whereas if the bit is 1, then the decoding engine 214 may elect

$$\left\{\left|+\right〉 , \left|-\right〉\right\}$$

as the basis for measuring the qubits of Q_{θ}.

At block 708, value of θ based on the measuring of the qubits within the sequence Q_{θ} may be derived. For example, the decoding engine 214 may then measure the qubits of Q_{θ} to obtain a value of θi, wherein 1 ≤ i ≤ k′. In an example, the decoding engine 214 within Bob may determine a decimal representation of θ₁θ₂ ... θ_{k′} to get the value of θ. It may be noted that since Id_{B} is a secret key, only the receiver 104 (i.e., Bob) can undertake the decoding of the value of θ.

At block 710, a modified message sequence Q¹_{A} may be derived based on the measured qubits. For example, once the value of θ is obtained, the decoding engine 214 may discard one or more measured qubits to retrieves the sequence Q¹_{A}.

At block 712, based on the modified message sequence Q¹_{A}, the n-bit message may be determined. For example, with the value of θ now known, the decoding engine 214 of receiver 104 may apply the inverse unitary operator U_{θ}⁻¹ to all qubits of Q¹_{A}. As a result of this operation, all the qubits of Q¹_{A} would thus be in

$$\left\{\left|0\right〉 , \left|1\right〉\right\}$$

basis. At this stage, the decoding engine 214 may measure these qubits in

$$\left\{\left|0\right〉 , \left|1\right〉\right\}$$

basis. If the i-th measurement result is

$$\left|0\right〉 ,$$

then the decoding engine 214 may concludes M′ᵢ = 0, else M′ᵢ = 1. In case of the latter, the decoding engine 214 may decode the classical bit Mᵢ′ of the string M′. Thereafter, the decoding engine 214 may compare the random check bits and calculate the error rate. If the error rate is negligible, then by discarding the check bits (which have the negligible error) from M′, the decoding engine 214 may retrieve the n-bit message M.

Although examples for the present description have been described in language specific to structural features and/or methods, it may be understood that the appended claims are not necessarily limited to the specific features or methods described. Rather, the specific features and methods are disclosed and explained as examples of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A quantum communication system, comprising:
a quantum processing unit;
an encoding engine coupled to the quantum processing unit, wherein the encoding engine is to:
prepare an encoded sequence of single-qubit states corresponding to bits within a bit string message, wherein the sequence of the single-qubit states is prepared based on a randomly selected arbitrary basis and wherein the bit string message is based on an n-bit message to be transmitted to the receiving system;
transmit the encoded sequence to a receiving system over a quantum communication channel; and
further transmit, to the receiving system, positions of qubits of a sequence of single qubits for decoding the encoded sequence by the receiving system.

2. The system as claimed in claim 1, wherein the positions of qubits of the sequence of single qubits are shared over a classical communication channel.

3. The system as claimed in claim 1, wherein the encoding engine to prepare the encoded sequence is to:
introduce a plurality of random check bits at random locations within the n-bit message to obtain the bit string message; and
generating a message sequence comprising a number of single qubits in a selected basis corresponding to each bit of the bit string message.

4. The system as claimed in claim 3, wherein the encoding engine is to generate the message sequence in a {|0〉, |1〉} basis.

5. The system as claimed in claim 3, wherein the encoding engine is to further:
based on a value of θ, select a unitary operator; and
apply the unitary operator on all the qubits of the message sequence to provide a modified message sequence Q¹_{A}.

6. The system as claimed in claim 5, wherein the encoding engine is to:
obtain a first sequence of single identity qubits, wherein the first sequence is based on an authentication identity of the quantum communication system;
randomly insert the qubits of the first sequence into the modified message sequence Q¹_{A} to obtain a message sequence Q²_{A};
determine a second sequence of single identity qubits, wherein the second sequence is based on an authentication identity of the receiving system; and
randomly insert the qubits of the second sequence into the message sequence Q²_{A} to obtain another message sequence Q³_{A}.

7. The system as claimed in claim 6, wherein the encoding engine is to:
encode the value of θ based on sequence of qubits Q_{θ}, wherein Q_{θ} is corresponding to a binary representation of θ; and
inserting the qubits of the sequence of the qubits Q_{θ} at random positions in the message sequence Q³_{A} to obtain a message sequence Q⁴_{A}.

8. The system as claimed in claim 7, wherein the encoding engine is to:
select a decoy sequence corresponding to a predefined number of decoy photons, wherein the sequence is composed based on {|0〉, |1〉, |+〉, |-〉}; and
insert qubits of the decoy sequence at random positions of the message sequence Q⁴_{A} to obtain the encoded sequence.

9. The system as claimed in claim 1, comprising a security engine coupled to the quantum processing unit, wherein the security engine is to:
share, with the receiving system, position information and basis information of decoy photons;
in response to the sharing of the position information and the basis information, receive from the receiving system a measurement of the decoy photons;
compare the measurement received from the receiving system with initial states of the decoy photon; and
based on the comparing, estimate presence of an impersonating system in the quantum channel.

10. The system as claimed in claim 9, wherein the security engine to estimate the presence of the impersonating system is to:
calculate an error in the quantum channel based on the comparing;
on determining a value of the error to be greater than a threshold, ascertain presence of the impersonating system in the quantum channel; and
terminate the communication with the receiving system on ascertaining the presence of the impersonating system in the quantum channel.

11. The system as claimed in claim 1, comprising an authentication engine coupled to the quantum processing unit, wherein the authentication engine is to:
communicate, to the receiving system, a position of a first sequence of single identity qubits, wherein the first sequence is based on an authentication identity of the quantum communication system, wherein the receiving system is to further:
obtain a set of measurement results from the receiving system based on the first sequence, wherein the measurement results are obtained by measuring the qubits in appropriate basis corresponding to an authentication identity of the quantum communication system; and
determine an error rate based on the set of measurement results to confirm the authenticity of the quantum communication system.

12. A method, comprising:
receiving by a receiving system over a quantum communication channel, an encoded sequence of single-qubit states corresponding to bits within a bit string message, wherein the sequence of the single-qubit states is prepared based on a randomly selected arbitrary basis and wherein the bit string message is based on an n-bit message;
receiving from a transmitting system information pertaining to position of qubits within a sequence Q_{θ};
measuring the qubits within the sequence Q_{θ} on bases corresponding to an authentication identity of the receiving system;
deriving value of θ based on the measuring of the qubits within the sequence Q_{θ};
deriving a modified message sequence Q¹_{A} based on the measured qubits; and
based on the modified message sequence Q¹_{A} determining the n-bit message.

13. The method as claimed in claim 12, wherein the encoded sequence is received over a quantum communication channel.

14. The method as claimed in claim 12, wherein the deriving the modified message sequence Q¹_{A} comprises:
based on the value of θ, determining an inverse unitary operator;
applying the inverse unitary operator to qubits of the modified message sequence Q¹_{A} to obtain the bit string message;
receive a set of random check bits from the sending system; and
discarding the bits corresponding to the check bits from the bit string message to obtain the n-bit message.

15. The method as claimed in claim 12, wherein to perform a security check, the method comprises:
receiving from the sending system, position information and basis information of decoy photons in the encoded sequence of single-qubit states;
based on the position information and the basis information, performing a measurement of the decoy photons; and
sharing measurement of the decoy photons with the sending system to check presence of an impersonating system eavesdropping on the quantum communication channel.

16. The method as claimed in claim 13, wherein to perform an authentication check, the method comprises:
receiving position of a first sequence of single identity qubits and a second sequence of single identity qubits from the sending system, wherein the first sequence is based on an authentication identity of the quantum communication system and wherein the second sequence is based on an authentication identity of the receiving system;
receiving a set of measurement results based on the first sequence and the second sequence from the sending system; and
determine a random number based on the set of measurement results to confirm the authenticity of the receiving system.

17. A non-transitory computer-readable medium comprising computer-readable instructions being executable by a quantum processing resource to:
prepare an encoded sequence of single-qubit states corresponding to bits within a bit string message, wherein the sequence of the single-qubit states is prepared based on a randomly selected arbitrary basis and wherein the bit string message is based on an n-bit message to be transmitted to the receiving system;
transmit the encoded sequence to a receiving system over a quantum communication channel; and
further transmit, to the receiving system, positions of qubits of a sequence of single qubits for decoding the encoded sequence by the receiving system.

18. The non-transitory computer-readable medium as claimed in claim 17, wherein the positions of qubits of the sequence of single qubits are shared over a classical communication channel.

19. The non-transitory computer-readable medium as claimed in claim 17, wherein the instruction are executable to further:
introduce a plurality of random check bits at random locations within the n-bit message to obtain the bit string message; and
generating a message sequence comprising a number of single qubits in a selected basis corresponding to each bit of the bit string message.

20. The system as claimed in claim 19, wherein the encoding engine is to generate the message sequence in a {|0〉, |1〉} basis.
